(19) United States
(12) Patent Application Publication
(10) Pub. No.: US 2010/0230405 A1
(43) Pub. Date: Sep. 16, 2010

(54) Biodegradable Resin Composition Utilized in the Manufacture of Biodegradable Containers, Biodegradable Containers, and Method of Manufacture

(75) Inventor: James Lee Strait, III, Winter Park, FL (US)

Correspondence Address: Angela M. Miller, Esquire;Lowndes, Drosdick, Doster Kantor & Reed, P.A., P.O. Box 2809, Orlando, FL, 32802-2809, US

(73) Assignee: NUVISION BIOPLASTICS, LLC, Winter Park, FL (US)

(21) Appl. No.: 12/722,313

(22) Filed: Mar. 11, 2010

Related U.S. Application Data
(60) Provisional application No. 61/159,174, filed on Mar. 11, 2009.

(51) Int. Cl. B65D 6/28; C08L 1/00; B29C 65/06

(52) U.S. Cl. 220/4.01; 106/162.9; 156/73.5; 523/128; 220/200

(57) ABSTRACT

A biodegradable resin composition utilized in the manufacture of biodegradable bottles and other biodegradable containers, and a method of manufacturing such containers via injection molding and ultrasonic welding. A biodegradable resin composition includes, in percent by weight: 1 to 80% starch; 1 to 8% cellulose; 1 to 5% sodium stearate; and 1 to 2% oleic acid. Another biodegradable resin composition includes, in percent by weight: 1 to 70% starch; 1 to 8% cellulose; 1 to 12% hydroxyl-polypropylene; and 1 to 5% calcium carbonate. Another biodegradable resin composition includes, in percent by weight: 1 to 30% starch; 1 to 40% poly(butylene adipate-co-terephthalate); 1 to 20% poly(lactic acid); and 1 to 5% hydrated magnesium silicate.

### CROSS-REFERENCE TO RELATED APPLICATION

This application claims priority to provisional application Ser. No. 61/159,174, filed on Mar. 11, 2009, entitled “Biodegradable Resin Composition utilized in the Manufacture of Biodegradable Containers, Biodegradable Containers, and Method of Manufacture.”

### BACKGROUND OF THE INVENTION

1. Field of the Invention

The present invention relates to biodegradable compositions utilized in the manufacture of biodegradable containers and method of manufacture. More specifically, the present invention relates to a biodegradable resin composition utilized in the manufacture of biodegradable bottles and other biodegradable containers, and the method of manufacturing such containers via injection molding and ultrasonic welding.

2. Description of Related Art

With the ever-increasing awareness of the depletion of Earth's non-renewable resources and the resulting increase in the need to protect same, a dramatic push for the manufacture and use of environmentally friendly products has been made. Products which are now considered “harmful to the environment”, which may be deemed as such due to the type(s) of materials in such product, the process in which such products are manufactured, or a combination of both, are now being replaced with more eco-friendly products, including biodegradable products.

Traditionally, plastics or resins have been petroleum-based and the manufacture of same consumes much energy, thereby classifying traditional plastics or resins as harmful to the environment or, at the very least, to be non-eco-friendly. To such end, more and more research has been performed in an attempt to manufacture resins that are biodegradable. For example, polyactic acid (PLA) plastic resins are marketed as biodegradable, as such resins are manufactured from corn and other vegetation. Microorganisms transform the sugars from the corn (and/or other vegetation) into lactic acid and the molecules of the lactic acid are chemically linked into chains of plastic. However, although the materials originally utilized in creating PLA are environmentally friendly, the method of treating the materials in order to produce the end result require chemical alteration.

Moreover, although there is a greater push towards biodegradable resin products, there are limited venues in which an end user may send the biodegradable resin product for recycling, as most recycling facilities are not equipped to process biodegradable resin.

Further, if an end user deposits the biodegradable resin product for recycling with conventional resins, such as polyethylene terephthalate, s/he ultimately contaminates the conventional resin for reuse.

### SUMMARY OF THE INVENTION

The present invention is directed to a biodegradable resin composition utilized in the manufacture of biodegradable bottles and other biodegradable containers, and the method of manufacturing such containers via injection molding and ultrasonic welding.

A biodegradable resin composition includes the following in percent by weight: 1 to 80% starch; 1 to 8% cellulose; 1 to 5% sodium stearate; and 1 to 2% oleic acid.

Another biodegradable resin composition includes the following in percent by weight: 1 to 70% starch; 1 to 8% cellulose; 1 to 12% hydroxyl-polypropylene; and 1 to 5% calcium carbonate.

Another biodegradable resin composition include the following in percent by weight: 1 to 30% starch; 1 to 40% poly(butylene adipate-co-terephthalate) (PBAT); 1 to 20% poly(lactic acid) (PLA); and 1 to 5% hydrated magnesium silicate.

The method of manufacturing biodegradable containers includes forming components of the container via injection molding and ultrasonically welding the components to one another.

### BRIEF DESCRIPTION OF THE DRAWINGS

FIG. 1 is a perspective view of a biodegradable container of the present invention in the form of a biodegradable bottle;

FIG. 2 is bottom plan view of the embodiment of FIG. 1;

FIG. 3 is a top plan view of a biodegradable container of the present invention in the form of a biodegradable bottle without a cap;

FIG. 4 is a cross-sectional view along line 4-4 of FIG. 1;

FIG. 5 is a side view of a base of the biodegradable container in the form of a biodegradable bottle of the present invention;

FIG. 6 is a side view of a base of the biodegradable container in the form of a biodegradable bottle having joints;

FIG. 7 is an enlarged view of a portion of FIG. 6;

FIG. 8 is a perspective view of a biodegradable container in the form of a biodegradable bottle having a body and a top;

FIG. 9 is a side view of a top of the biodegradable bottle of FIG. 8;

FIG. 10 is a perspective view of a body of FIG. 8;

FIG. 11 is a cross-sectional view along line 11-11 of FIG. 8;

FIG. 12 is a cross-sectional view along line 12-12 of FIG. 10;

FIG. 13 is a side view of a biodegradable container in the form of a biodegradable bottle having a top and a body;

FIG. 14 is a cross-sectional view along line 14-14 of FIG. 13;

FIG. 15 is a side view of a top of FIG. 13;

FIG. 16 is a side view of a body of FIG. 13;

FIG. 17 is a side view of a biodegradable container in the form of a biodegradable bottle;

FIG. 18 is a cross-sectional view along line 18-18 of FIG. 17;

FIG. 19 is a side view of a base of the biodegradable container in the form of a biodegradable bottle of FIG. 17; and

FIG. 20 is an enlarged view of a portion of FIG. 19.

### DETAILED DESCRIPTION OF THE PREFERRED EMBODIMENTS

A description of the preferred embodiments of the present invention will now be presented.

The present invention relates to biodegradable resin bottles and other biodegradable containers, such as, but not limited to, pharmaceutical containers, shampoo containers, mouthwash containers, and any other type of container, comprising a biodegradable resin composition having a softening point of approximately 257 degrees Fahrenheit, a melting point of approximately 313 degrees Fahrenheit, extended heating capabilities that last for approximately one hour at 250 degrees Fahrenheit, a specific density of approximately 1.2, and a flow rate of between approximately 0.5 and 2.0 g/10 minutes.

The present invention also relates to a method of manufacturing biodegradable resin bottles and other containers having the aforementioned composition.

A biodegradable resin composition includes approximately eighty percent (80%) starch, approximately eight percent (8%) cellulose, approximately five percent (5%) sodium stearate, approximately two percent (2%) oleic acid, and approximately five percent (5%) other ingredients. This biodegradable resin composition naturally biodegrades in compost, wet soil, fresh water, seawater and activated sludge where microorganisms exist, is compostable, is recyclable, and is renewable.

Another biodegradable resin composition includes the following in percent by weight: 1 to 70% starch; 1 to 8% cellulose; 1 to 12% hydroxyl-polypropylene; 1 to 5% calcium carbonate; and the balance being other ingredients. This biodegradable resin composition naturally biodegrades in compost, wet soil, fresh water, seawater and activated sludge where microorganisms exist and is renewable.

Another biodegradable resin composition include the following in percent by weight: 1 to 30% starch; 1 to 40% poly(butylene adipate-co-terephthalate); 1 to 20% poly(lactic acid); 1 to 5% hydrated magnesium silicate; and the balance being other ingredients. This biodegradable resin composition naturally biodegrades in compost, wet soil, fresh water, seawater and activated sludge where microorganisms exist and is compostable.

The starch may be selected from a corn starch, wheat starch, potato starch, sweet potato starch, or tapioca starch.

Over time, products manufactured from the biodegradable resin composition of the present invention naturally biodegrade without non-environmental chemical, heat, or other forms of treatment.

The use of the term “biodegradable” herein is intended to include those compositions and the containers made therefrom that may result in a certain amount of biodegrading over a course of time and is not specifically limited to those compositions and containers made therefrom that do not completely biodegrade.

Similarly, use of the term “renewable” herein is intended to include those compositions and the containers made therefrom that may result in a certain amount of replacement or replenishing over a course of time and is not specifically limited to those compositions and containers made therefrom that do not result in complete renewal.

To manufacture bottles and other containers utilizing the biodegradable resin composition, a combination of injection molding and ultrasonic welding is utilized. The main components of a biodegradable bottle include a body, a base, and cap. Each of the components of the biodegradable bottle can be manufactured, for example, via conventional injection molding techniques and in accordance with the additional/alternative specifications set forth below. After each component is manufactured, the body and the base can be ultrasonically welded to one another. The cap can be of a conventional screw-on style, but may be of any other shape or style so long as it permits a user to seal an open end of the bottle body.

The particles of the biodegradable resin composition may be mixed with other biodegradable resin compositions, additives, and dyes to manufacture bottles and other containers.

To manufacture bottles and other containers utilizing the biodegradable resin composition identified above, traditional injection molding practices can be utilized with additional/alternative specifications. Traditional injection molding includes the utilization of at least one injection molding machine and commonly includes the following steps: feeding a resin composition into the injection molding machine via a hopper, entering the resin composition into an injection barrel by gravity via a feed throat, heating and melting the resin composition upon entrance into the barrel, and injecting the melted resin composition into a mold by a reciprocating screw or a ram injector. The mold, which is the component of the injection molding machine that receives the melted resin composition and shapes it, is formed of two plates that are held together by mechanical or hydraulic force. The resin composition enters the mold through a sprue in the first plate, branches out between the two sides through channels called runners, and enters each part cavity through at least one gate. Within each cavity, the resin composition flows around protrusions and conforms to shape of the cavity so as to form the desired shape. The mold is then cooled to a temperature that permits the melted resin composition within the cavity to solidify.

With specific respect to the manufacture of the biodegradable resin composition of the present invention into bottles and other containers, the sprue and runners of the mold design should be larger as compared to the sprues and runners of conventional mold designs so as to accommodate the biodegradable resin composition's lower flow rate as compared to traditional resins.

In addition, the mold plate's thickness should also be greater as compared to the thickness of traditional mold plates. For example, the percentage increase in thickness of the mold plates utilized in the manufacturing method of the present invention as compared to traditional mold plates could be thirty percent (30%).

If the mold cavity is large, a padding block should be added to the bed die to ensure that the mold plate will not distort under injection pressure. Pinpoint gates and fan gates should be utilized so as to ensue smooth flow of melting materials. Special attention should be taken when monitoring the flow of melting materials around corners so as to avoid or minimize the effects associated with back-up of the melting materials.

After completion of the injection molding phase, the biodegradable resin composition may be dried. Ideally, the resin should be dried at 85 degrees Celsius for approximately four hours. Upon completion, the biodegradable resin composition should contain no more than one percent (1%) moisture.

The biodegradable resin composition compounds easily with polypropylene. The extruder should be completely purged with polypropylene prior to introduction of the biodegradable resin composition. While purging the biodegradable resin composition, ideally one should begin with the biodegradable resin composition mixed with polypropylene and slowly increase the biodegradable resin composition percentage incrementally, thereby slowly reducing the polypropylene percentage.

The temperature setting for injection molding should be set between approximately 170 and 205 degrees Celsius, dependent upon the weight of the resulting injection molded products and the size of the injection molding machine. The temperature of the adjusted dies should range between approximately 50 and 80 degrees Celsius. Runners having a temperature of approximately 60 degrees Celsius assist in maintaining an ideal flow rate of the biodegradable resin composition.

To process the biodegradable resin composition, compression and speed of the injection molding should be determined according to molding area and weight and will most likely result with the compression and speed of the injection molding being greater than that of other resins, such as polyethylene, polypropylene, and general purpose polystyrene.

In the course of processing, white mineral oil, coconut oil, or other comparable oils may be added to the biodegradable resin composition and pre-blended so as to improve fluidity of the biodegradable resin composition during injection molding. Additionally or in the alternative, polyethylene and/or polypropylene may be added to the biodegradable resin composition to improve fluidity and shock resistance of the biodegradable resin composition. The addition of such other resins should be limited to a range of between approximately five percent (5%) and twenty percent (20%).

During blending and dyeing of the biodegradable resin composition, organic or inorganic dyestuff may be added to the particles of the biodegradable resin composition. The dyestuff should be blended for approximately 15 to 20 minutes.

Once the biodegradable resin bottles or other containers are manufactured via injection molding, the components of the bottles or holding containers that should be permanently sealed to one another are done so via ultrasonic welding.

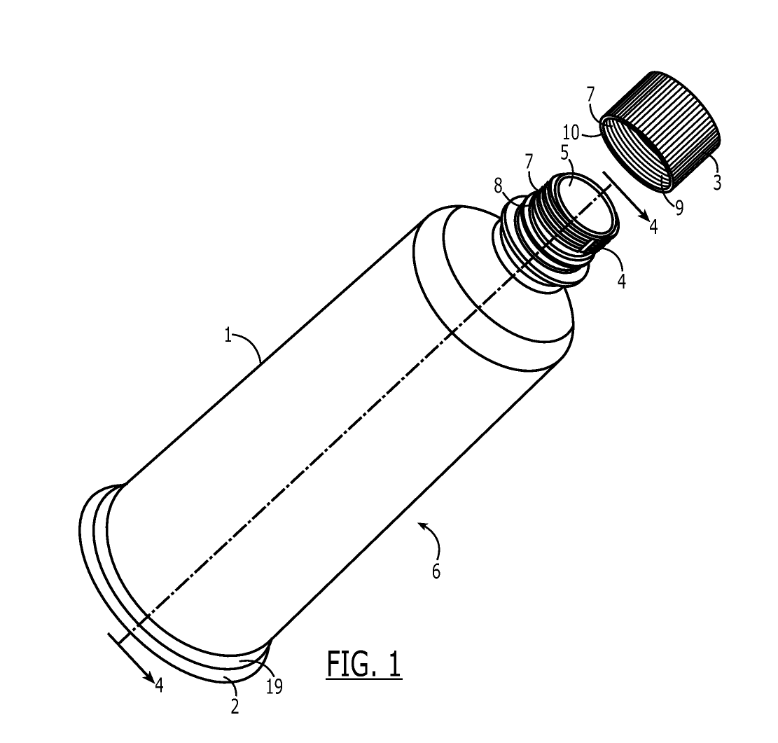

For instance, in manufacturing a biodegradable container of the present invention as shown in the form of a biodegradable bottle in FIG. 1, three components of the bottle are manufactured via injection molding: a body 1, a base 2, and a cap 3. The base 2 is permanently joined to a lower end 19 of the body 1 via ultrasonic welding. An upper portion 4 of the body 1 includes an opening 5 to permit liquid or other items located within the bottle 6 to be removed. A closure means 7 is provided to permit a user to removably close the opening 5 of the bottle 6 as desired. As shown, the closure means 7 comprises the upper portion 4 of the body 1 having external threads 8 and an interior area 9 of the cap 3 having mating internal threads 10 that correspond to the external threads 8 of the cap 3. In this manner, a user may twist the cap 3 on and off of the bottle 6. However, other known closure means 7 may be utilized.

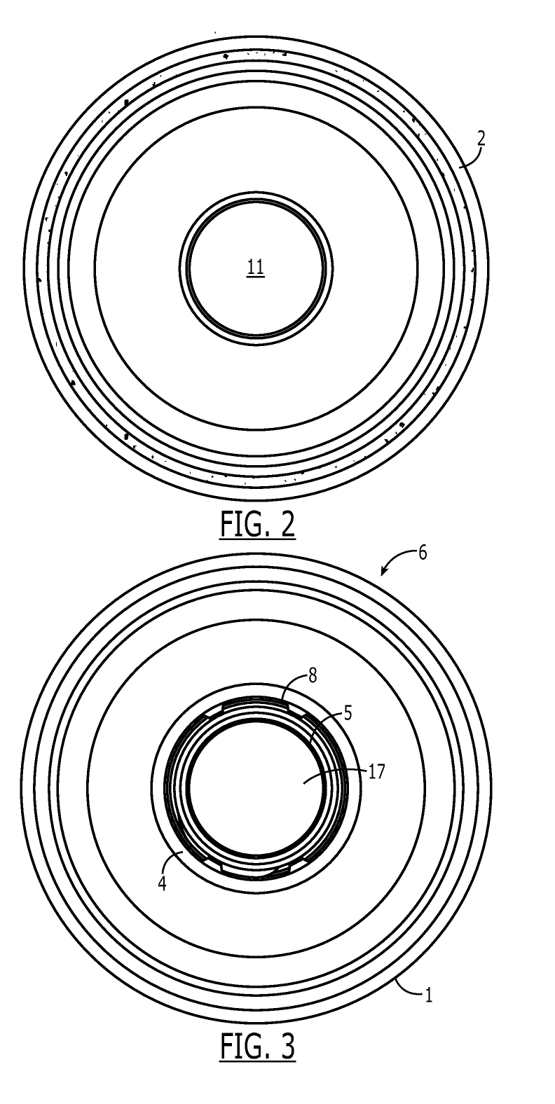

In FIG. 2, a bottom plan view of the embodiment of FIG. 1 is shown. The base 2 of the biodegradable bottle 6 may include a raised central portion 11, although one is not necessary for the use and practice of the present invention.

FIG. 3 shows a top plan view of a biodegradable container of the present invention in the form of a biodegradable bottle 6 without a cap 3. The biodegradable bottle 6 includes an opening 5, as is commonly utilized in many drinking containers, food containers, and other holding containers in general, to permit access to an internal cavity 17 through which liquid or other items may be passed.

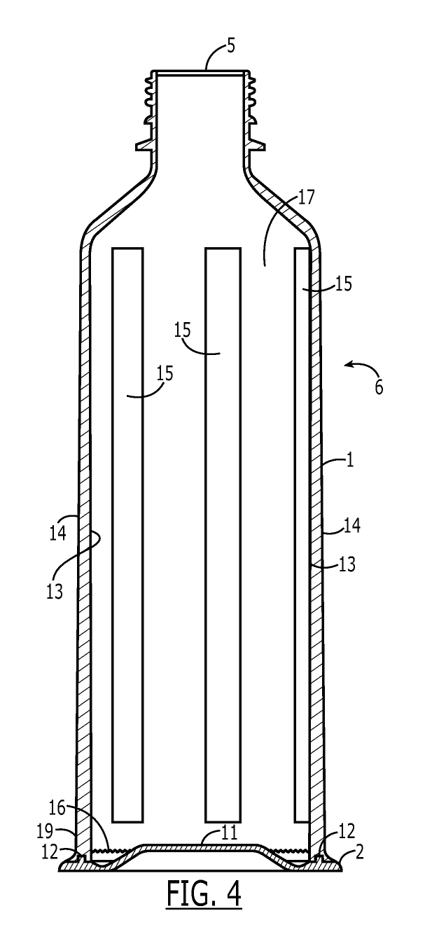

With reference to FIG. 4, a cross-sectional view along line 4-4 of FIG. 1 is shown. The body 1 of the biodegradable bottle 6 is manufactured via injection molding wherein, when formed, an internal wall 13 and external wall 14 are created. The body 1 has a predetermined thickness, which by way of example may be 0.068 inches. However, other thicknesses may be utilized.

At least one rib 15 may extend vertically along the internal wall 13 of the biodegradable bottle 6 so as to increase the rigidity of the biodegradable bottle 6. Optional joints 12 and saw teeth 16 may extend upwardly from the base 2 of the biodegradable bottle 6.

After the body 1 and the base 2 are formed via injection molding and are cooled, the body 1 and the base 2 are permanently joined together via ultrasonic welding along the saw teeth 16 and the joints 12. The joints 12 to permit a greater and longer-lasting seal between the body 1 and the base 2. Examples of such types of joints include, but are not limited to, dovetail joints, biscuit joints, box joints, dado joints, domino joints, dowel butt joints, finger joints, and lap joints. Thus, the joints 12 may be manipulated so as to interlock with the body 1 prior to ultrasonically welding the base 2 to the body 1, thereby permitting a stronger seal to be created between the base 2 and the body 1.

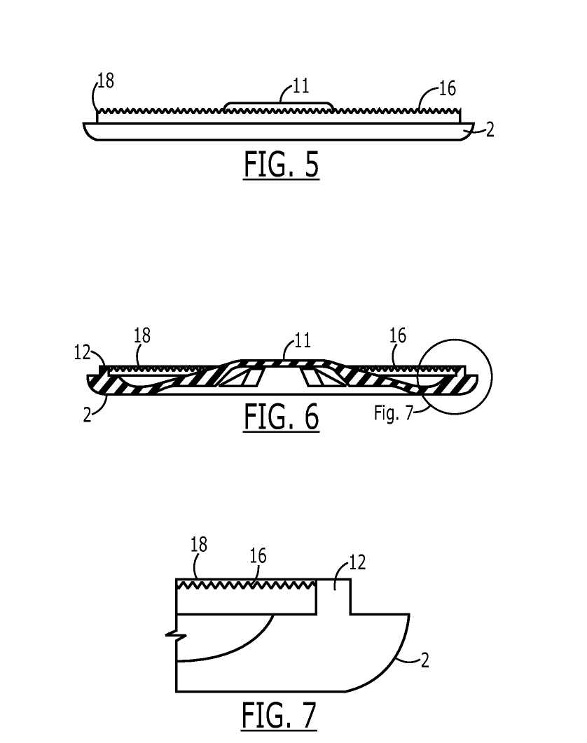

FIG. 5 shows a side view of a base of biodegradable container of the present invention with the container in the form of a biodegradable bottle 6. The base 2 includes a plurality of saw teeth 16 on a top face 18 thereof, which aid in creating a stronger bond between the body 1 and the base 2 when ultrasonically welded to one another. Although saw teeth 16 are shown, other types of edging along the base 2 and/or body 1 may be envisioned, including, but not limited to, jagged edging, curved edging, linear edging, etc. The saw teeth 16 may be used alone or in conjunction with joints 12 to secure the top 20 to the body 1 and/or the base 2 to the body 1 as further described below.

With reference to FIGS. 6 and 7, a side view and enlarged view of a base of the biodegradable container of the present invention in the form of a biodegradable bottle 6 of the present invention having joints is shown. The joints 12 extend from the base 2 and, when interlocked with the body 1 and ultrasonically welded to one another, aid in creating a stronger bond between the body 1 and the base 2.

In manufacturing a biodegradable container of the present invention as shown in the form of a biodegradable bottle in FIG. 8, three components of the bottle are manufactured via injection molding: a body 1, a top 20, and a cap 3 (not shown). An upper portion 4 of the top 20 includes an opening 5 to permit liquid or other items located within the bottle 6 to be removed. A closure means 7 is provided to permit a user to removably close the opening 5 of the bottle 6 as desired similar to the biodegradable bottle 6 as shown in and as described with reference to FIG. 1. However, other known closure means 7 may be utilized.

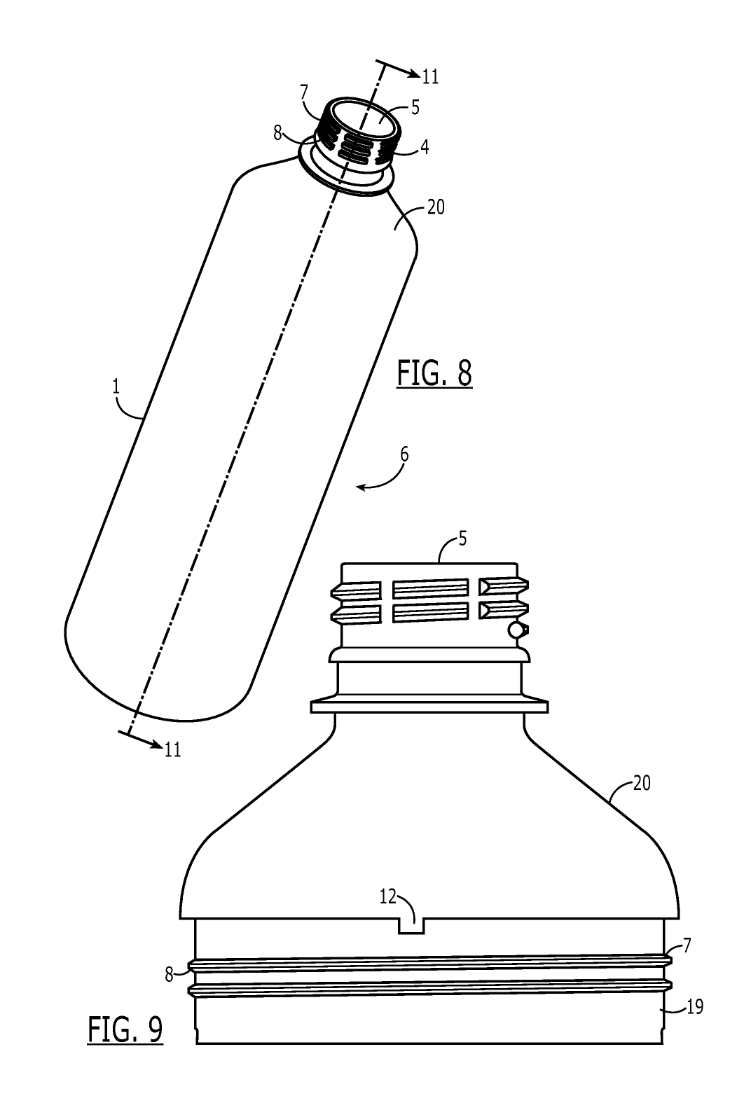

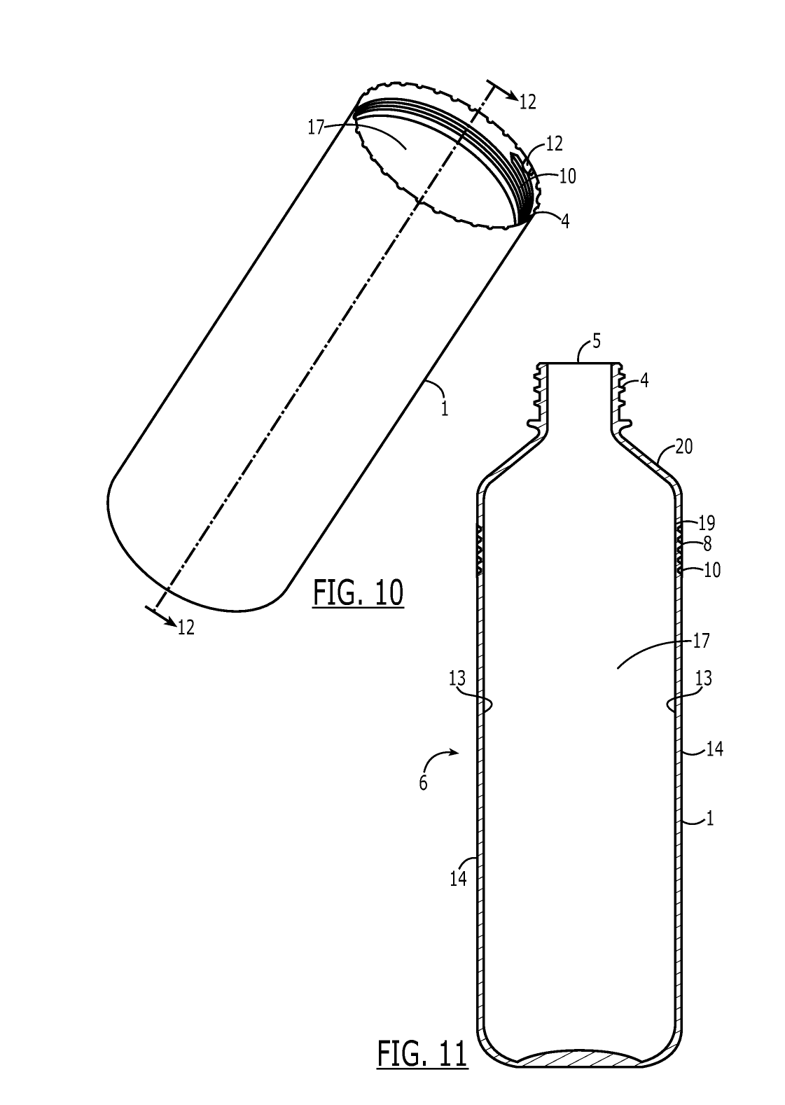

FIGS. 9 and 10 show perspective views of a top and body, respectively, of the biodegradable bottle of FIG. 8. The top 20 may include a lower portion 19 which may include at least one closure means 7, such as external threads 8, thereon. An upper portion 4 of the body 1 may also include at least one closure means 7, such as mating internal threads 10. The internal threads 10 may be located on the internal wall 13 of the body 1 near an upper portion 4 of the body 1. The external threads 8 and internal threads 10 permit a locking fit between the top 20 and body 1 of the biodegradable bottle 6. Joints 12 may be located on the lower portion 19 of the top 20 and on the upper portion 4 of the body 1 to permit a greater and longer-lasting seal between the body 1 and the base 2. Examples of such types of joints include, but are not limited to, dovetail joints, biscuit joints, box joints, dado joints, domino joints, dowel butt joints, finger joints, and lap joints. Thus, the joints 12 may be manipulated so as to interlock with the body 1 prior to ultrasonically welding the top 20 to the body 1, thereby permitting a stronger seal to be created between the top 20 and the body 1.

FIG. 11 shows a cross-sectional view along line 11 of FIG. 8 wherein the top 20 and the body 1 are matingly secured to one another via the internal threads 10 and external threads 9.

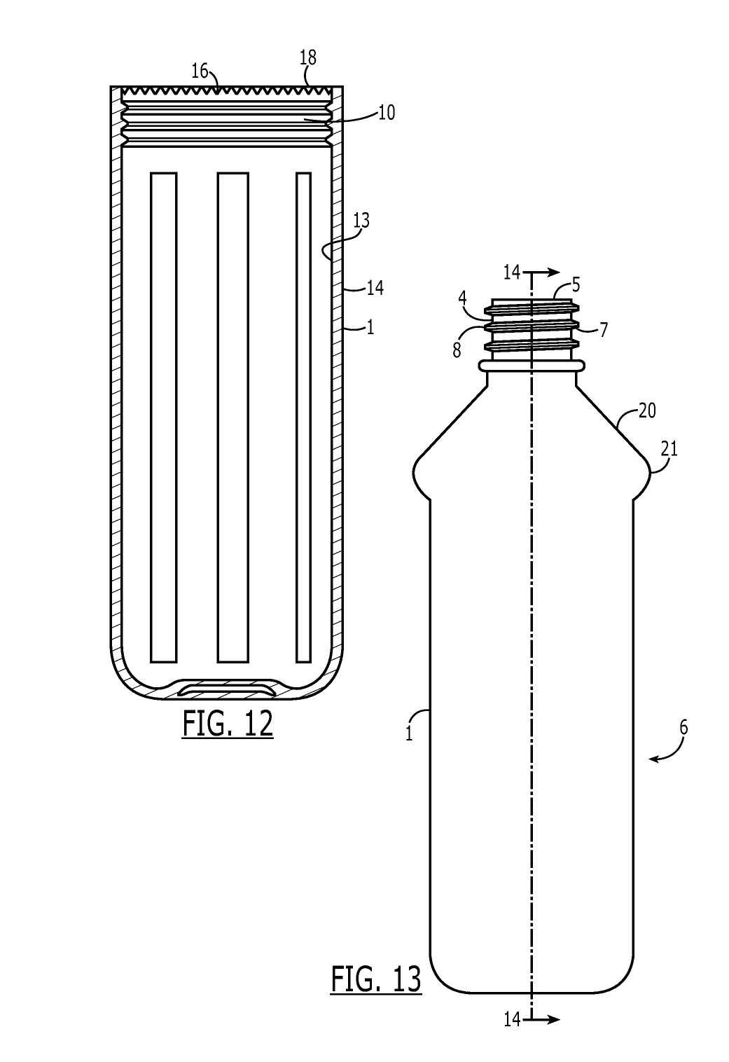

With reference to FIG. 12, a cross-sectional view along line 12-12 of FIG. 10 is shown. The body 1 of the biodegradable bottle 6 is manufactured via injection molding wherein, when formed, an internal wall 13 and external wall 14 are created. The body 1 has a predetermined thickness, which by way of example may be 0.068 inches. However, other thicknesses may be utilized. At least one rib 15 may extend vertically along the internal wall 13 of the biodegradable bottle 6 so as to increase the rigidity of the biodegradable bottle 6.

The body 1 includes a plurality of saw teeth 16 on a top face 18 of an upper end 21 of the body 1, which aid in creating a stronger bond between the top 20 and the body 1 when ultrasonically welded to one another. After the top 20 and body 1 are formed via injection molding and are cooled, the top 20 and the body 1 are twist-fit to one another, interlocked with one another via the joints 12, and permanently joined together via ultrasonic welding along saw teeth 16 and the joints 12. Although saw teeth 16 are shown, other types of edging along the top 20 and/or body 1 may be envisioned, including, but not limited to, jagged edging, curved edging, linear edging, etc.

In manufacturing a biodegradable container of the present invention in the form of a biodegradable bottle 6 as shown in FIG. 13, three components of the bottle are manufactured via injection molding: a body 1, a top 20, and a cap 3 (not shown). The top 20 is permanently joined to an upper end 21 of the body 1 via ultrasonic welding. An upper portion 4 of the top 20 includes an opening 5 to permit liquid or other items located within the bottle 6 to be removed. A closure means 7 is provided to permit a user to removably close the opening 5 of the bottle 6 as desired. As shown, the closure means 7 comprises the upper portion 4 of the body 1 having external threads 8 and an interior area 9 of the cap 3 having mating internal threads 10 that correspond to the external threads 8 of the cap 3. In this manner, a user may twist the cap 3 on and off of the bottle 6. However, other closure means 7 may be utilized.

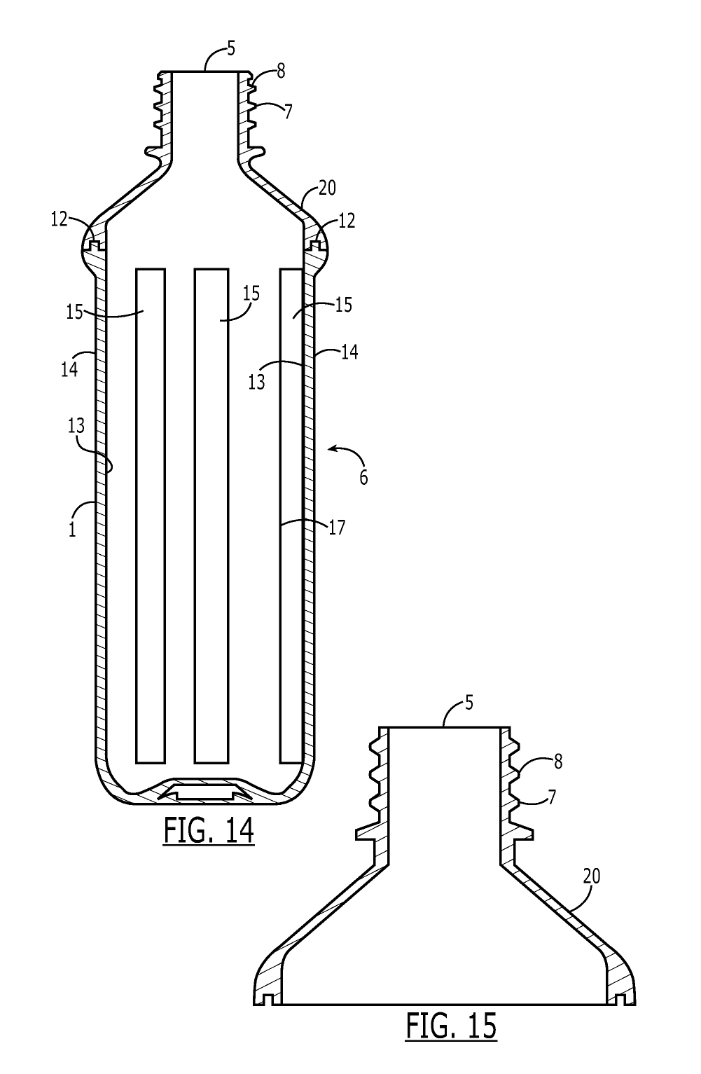

With reference to FIG. 14, a cross-sectional view along line 14-14 of FIG. 13 is shown. The body 1 of the biodegradable bottle 6 is manufactured via injection molding wherein, when formed, an internal wall 13 and external wall 14 are created. The body 1 has a predetermined thickness, which by way of example may be 0.068 inches. However, other thicknesses may be utilized. At least one rib 15 may extend vertically along the internal wall 13 of the biodegradable bottle 6 so as to increase the rigidity of the biodegradable bottle 6.

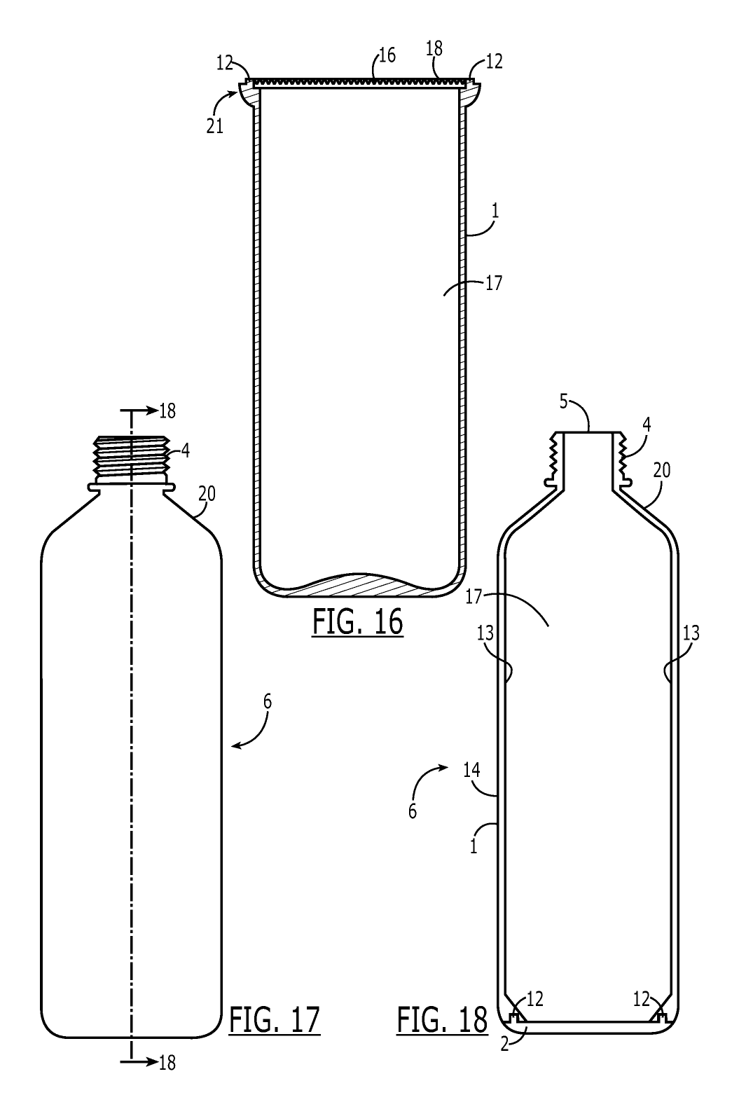

With reference to FIGS. 15 and 16, enlarged views of a top and body of the biodegradable bottle are shown, respectively. The body 1 includes a plurality of saw teeth 16 on a top face 18 of an upper end 21 of the body 1, which aid in creating a stronger bond between the top 20 and the body 1 when ultrasonically welded to one another. After the top 20 and body 1 are formed via injection molding and are cooled, the top 20 and the body 1 are interlocked with one another via the joints 12 and permanently joined together via ultrasonic welding along saw teeth 16 and the joints 12. Although saw teeth 16 are shown, other types of edging along the top 20 and/or body 1 may be envisioned, including, but not limited to, jagged edging, curved edging, linear edging, etc.

With reference to FIGS. 17 and 18, varying views of a biodegradable container of the present invention in the form of a biodegradable bottle 6 is shown without a cap. The biodegradable bottle 6 includes joints 12 for ultrasonically welding the base 2 to the body 1.

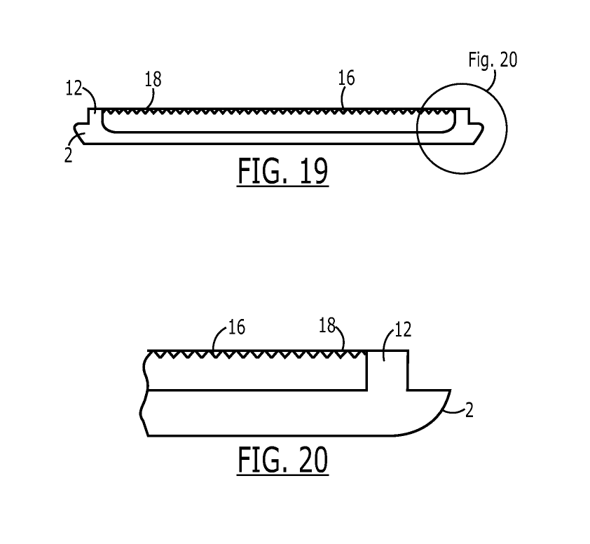

With reference to FIGS. 19 and 20, a side view and enlarged view of a base of the biodegradable container of the present invention in the form of a biodegradable bottle 6 of the present invention having joints is shown. The joints 12 extend from the base 2 and, when interlocked with the body 1 and ultrasonically welded to one another, aid in creating a stronger bond between the body 1 and the base 2.

The body 1, base 2, and top 20 may be opaque, translucent, or a combination thereof.

Additionally, the biodegradable bottle or other biodegradable container may be of varying shapes and sizes, dependent upon the dimensions of the body 1, base 2, and top 20. For instance, the body 1 and base 2 may be of the same length or differing lengths, thereby resulting in varying locations of the base 2 to body 1 weld in relation to the overall height of the biodegradable bottle or other biodegradable container and different overall heights of the biodegradable bottle or other biodegradable container. Similarly, the body 1 and the top 20 may be of the same length or differing lengths, once again resulting in varying weld locations relative to the height of the biodegradable bottle or other biodegradable container and different over heights of same. Lastly, the base 2 and the top 20 may be of the same length of differing lengths, once again resulting in varying weld locations relative to the height of the biodegradable bottle or other biodegradable container and different over heights of same.

Finally, although the biodegradable container of the present invention is shown in the form of a biodegradable bottle, this invention is not limited to a biodegradable bottle only, but includes other biodegradable containers including, but not limited to, pharmaceutical containers, shampoo containers, mouthwash containers, and any other type of biodegradable container.

Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

What is claimed is:

1. A biodegradable resin composition comprising, in percent by weight, 1 to 80% starch, 1 to 8% cellulose, 1 to 5% sodium stearate, and 1 to 2% oleic acid.

2. A biodegradable container comprising:
a body and a base ultrasonically welded to a lower end of the body, the body and the base comprising 1 to 80% starch, 1 to 8% cellulose, 1 to 5% sodium stearate, and 1 to 2% oleic acid; and
a cap affixable to removably seal an opening in the body adjacent an upper portion thereof.

3. The biodegradable container of claim 2, wherein the base has at least one joint located on a top face thereof for improving a seal formed during ultrasonic welding of the base to the lower end of the body.

4. The biodegradable container of claim 3, wherein the base has saw teeth located on a top face thereof for improving a seal formed during ultrasonic welding of the base to the lower end of the body.

5. The biodegradable container of claim 4, wherein the body comprises at least one rib located on an internal wall thereof for increasing rigidity thereof.

6. The biodegradable container of claim 3, wherein the body comprises at least one rib located on an internal wall thereof for increasing rigidity thereof.

7. The biodegradable container of claim 2, wherein the base has saw teeth located on a top face thereof for improving a seal formed during ultrasonic welding of the base to the lower end of the body.

8. The biodegradable container of claim 7, wherein the body comprises at least one rib located on an internal wall thereof for increasing rigidity thereof.

9. The biodegradable container of claim 2, wherein the body comprises at least one rib located on an internal wall thereof for increasing rigidity thereof.

10. A method of manufacturing a biodegradable container comprising:
forming a body via injection molding from a utilizing a biodegradable resin composition comprising, in percent by weight: 1 to 80% starch; 1 to 8% cellulose; 1 to 5% sodium stearate; and 1 to 2% oleic acid;
forming a base via injection molding from the biodegradable resin composition; and
ultrasonically welding the base to the body at a lower end thereof.

11. A biodegradable container comprising:
a body and a top ultrasonically welded to an upper end of the body, the top and the body comprising 1 to 80% starch, 1 to 8% cellulose, 1 to 5% sodium stearate, and 1 to 2% oleic acid; and
a cap affixable to removably seal an opening in the top adjacent a upper portion thereof.

12. The biodegradable container of claim 11, wherein the body has at least one joint located on a top face thereof for improving a seal formed during ultrasonic welding of the base to the lower end of the body.

13. The biodegradable container of claim 12, wherein the body has saw teeth located on a top face thereof for improving a seal formed during ultrasonic welding of the base to the lower end of the body.

14. The biodegradable container of claim 13, wherein the body comprises at least one rib located on an internal wall thereof for increasing rigidity thereof.

15. The biodegradable container of claim 14, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

16. The biodegradable container of claim 13, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

17. The biodegradable container of claim 12, wherein the body comprises at least one rib located on an internal wall thereof for increasing rigidity thereof.

18. The biodegradable container of claim 17, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

19. The biodegradable container of claim 12, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

20. The biodegradable container of claim 11, wherein the body has saw teeth located on a top face thereof for improving a seal formed during ultrasonic welding of the base to the lower end of the body.

21. The biodegradable container of claim 20, wherein the body comprises at least one rib located on an internal wall thereof for increasing rigidity thereof.

22. The biodegradable container of claim 21, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

23. The biodegradable container of claim 20, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

24. The biodegradable container of claim 11, wherein the body comprises at least one rib located on an internal wall thereof for increasing rigidity thereof.

25. The biodegradable container of claim 24, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

26. The biodegradable container of claim 11, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

27. A method of manufacturing a biodegradable container comprising:
forming a body via injection molding utilizing a biodegradable resin composition comprising, in percent by weight: 1 to 80% starch; 1 to 8% cellulose; 1 to 5% sodium stearate; and 1 to 2% oleic acid,
forming a top via injection molding; and
ultrasonically welding the top to the body at an upper end thereof.

28. A biodegradable resin composition comprising, in percent by weight, 1 to 70% starch, 1 to 8% cellulose, 1 to 12% hydroxyl-polypropylene, and 1 to 5% calcium carbonate.

29. A biodegradable container comprising:
a body and a base ultrasonically welded to a lower end of the body, the body and the base comprising 1 to 70% starch, 1 to 8% cellulose, 1 to 12% hydroxyl-polypropylene, and 1 to 5% calcium carbonate; and
a cap affixable to removably seal an opening in the body adjacent a upper portion thereof.

30. The biodegradable container of claim 29, wherein the base has at least one joint located on a top face thereof for improving a seal formed during ultrasonic welding of the base to the lower end of the body.

31. The biodegradable container of claim 30, wherein the base has saw teeth located on a top face thereof for improving a seal formed during ultrasonic welding of the base to the lower end of the body.

32. The biodegradable container of claim 31, wherein the body comprises at least one rib located on an internal wall thereof for increasing rigidity thereof.

33. The biodegradable container of claim 30, wherein the body comprises at least one rib located on an internal wall thereof for increasing rigidity thereof.

34. The biodegradable container of claim 29, wherein the base has saw teeth located on a top face thereof for improving a seal formed during ultrasonic welding of the base to the lower end of the body.

35. The biodegradable container of claim 34, wherein the body comprises at least one rib located on an internal wall thereof for increasing rigidity thereof.

36. The biodegradable container of claim 29, wherein the body comprises at least one rib located on an internal wall thereof for increasing rigidity thereof.

37. A biodegradable container comprising:
a body and a base ultrasonically welded to a upper end of the body, the body and the base comprising 1 to 70% starch, 1 to 8% cellulose, 1 to 12% hydroxyl-polypropylene, and 1 to 5% calcium carbonate; and
a cap affixable to removably seal an opening in the body adjacent a upper portion thereof.

38. The biodegradable container of claim 37, wherein the base has saw teeth located on a top face thereof for improving a seal formed during ultrasonic welding of the base to the lower end of the body.

39. The biodegradable container of claim 38, wherein the base has saw teeth located on a top face thereof for improving a seal formed during ultrasonic welding of the base to the lower end of the body.

40. The biodegradable container of claim 39, wherein the body comprises at least one rib located on an internal wall thereof for increasing rigidity thereof.

41. The biodegradable container of claim 40, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

42. The biodegradable container of claim 39, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

43. The biodegradable container of claim 38, wherein the body comprises at least one rib located on an internal wall thereof for increasing rigidity thereof.

44. The biodegradable container of claim 43, wherein the body comprises at least one rib located on an internal wall thereof for increasing rigidity thereof.

45. The biodegradable container of claim 44, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

46. The biodegradable container of claim 43, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

47. The biodegradable container of claim 38, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

48. The biodegradable container of claim 37, wherein the body comprises at least one rib located on an internal wall thereof for increasing rigidity thereof.

49. The biodegradable container of claim 48, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

50. The biodegradable container of claim 37, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

51. The biodegradable container of claim 50, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

52. A method of manufacturing a biodegradable container comprising:
forming a body via injection molding from a biodegradable resin composition which includes the following in percent by weight: 1 to 70% starch; 1 to 8% cellulose; 1 to 12% hydroxyl-polypropylene; and 1 to 5% calcium carbonate;
forming a top via injection molding from the biodegradable resin composition; and
ultrasonically welding the top to the body at an upper end thereof.

53. A biodegradable resin composition comprising, in percent by weight, 1 to 30% starch, 1 to 40% poly(butylene adipate-co-terephthalate), 1 to 20% poly(lactic acid), and 1 to 5% hydrated magnesium silicate.

54. A biodegradable container comprising:
a body and a base ultrasonically welded to a lower end of the body, the body and the base comprising 1 to 30% starch, 1 to 40% poly(butylene adipate-co-terephthalate), 1 to 20% poly(lactic acid), and 1 to 5% hydrated magnesium silicate; and
a cap affixable to removably seal an opening in the body adjacent a upper portion thereof.

55. The biodegradable container of claim 54, wherein the base has at least one joint located on a top face thereof for improving a seal formed during ultrasonic welding of the base to the lower end of the body.

56. The biodegradable container of claim 55, wherein the base has saw teeth located on a top face thereof for improving a seal formed during ultrasonic welding of the base to the lower end of the body.

57. The biodegradable container of claim 56, wherein the body comprises at least one rib located on an internal wall thereof for increasing rigidity thereof.

58. The biodegradable container of claim 55, wherein the body comprises at least one rib located on an internal wall thereof for increasing rigidity thereof.

59. The biodegradable container of claim 54, wherein the base has saw teeth located on a top face thereof for improving a seal formed during ultrasonic welding of the base to the lower end of the body.

60. The biodegradable container of claim 59, wherein the body comprises at least one rib located on an internal wall thereof for increasing rigidity thereof.

61. The biodegradable container of claim 54, wherein the body comprises at least one rib located on an internal wall thereof for increasing rigidity thereof.

62. A biodegradable container comprising:
a body and a base ultrasonically welded to a upper end of the body, the body and the base comprising 1 to 30% starch, 1 to 40% poly(butylene adipate-co-terephthalate), 1 to 20% poly(lactic acid), and 1 to 5% hydrated magnesium silicate; and
a cap affixable to removably seal an opening in the body adjacent a upper portion thereof.

63. The biodegradable container of claim 62, wherein the base has saw teeth located on a top face thereof for improving a seal formed during ultrasonic welding of the base to the lower end of the body.

64. The biodegradable container of claim 63, wherein the base has saw teeth located on a top face thereof for improving a seal formed during ultrasonic welding of the base to the lower end of the body.

65. The biodegradable container of claim 64, wherein the body comprises at least one rib located on an internal wall thereof for increasing rigidity thereof.

66. The biodegradable container of claim 65, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

67. The biodegradable container of claim 64, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

68. The biodegradable container of claim 63, wherein the body comprises at least one rib located on an internal wall thereof for increasing rigidity thereof.

69. The biodegradable container of claim 68, wherein the body comprises at least one rib located on an internal wall thereof for increasing rigidity thereof.

70. The biodegradable container of claim 69, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

71. The biodegradable container of claim 68, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

72. The biodegradable container of claim 63, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

73. The biodegradable container of claim 62, wherein the body comprises at least one rib located on an internal wall thereof for increasing rigidity thereof.

74. The biodegradable container of claim 73, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

75. The biodegradable container of claim 62, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

76. The biodegradable container of claim 75, wherein:
the top has a lower portion extending therefrom, the lower portion having at least one external thread located thereon; and
the body has at least one internal thread located on an internal wall of the upper end thereof, wherein the at least one external thread matingly corresponds to the at least one internal thread for securing the top to the body.

77. A method of manufacturing a biodegradable container comprising:
forming a body via injection molding from a biodegradable resin composition which includes the following in percent by weight: 1 to 30% starch; 1 to 40% poly(butylene adipate-co-terephthalate); 1 to 20% poly(lactic acid); and 1 to 5% hydrated magnesium silicate;
forming a top via injection molding from the biodegradable resin; and
ultrasonically welding the top to the body at an upper end thereof.
